(19) United States
(12) Patent Application Publication
(10) Pub. No.: US 2016/0298672 A1
(43) Pub. Date: Oct. 13, 2016

(54) Stud Seating Assembly and Method

(71) Applicant: Electro-Motive Diesel, Inc., LaGrange, IL (US)

(72) Inventor: Robert T. MacVicar, Downers Grove, IL (US)

(73) Assignee: Electro-Motive Diesel, Inc., LaGrange, IL (US)

(21) Appl. No.: 14/680,466

(22) Filed: Apr. 7, 2015

(51) Int. Cl. F16B 35/04; F16B 37/00

(52) U.S. Cl. CPC F16B 35/044; F16B 37/00

(57) ABSTRACT

A stud seating method includes inserting a base end of the stud into a threaded hole and threadably mating an external thread of the stud with an internal thread of the threaded hole. The external thread is sized to have a clearance thread fit relative to the internal thread. The stud is advanced into the threaded hole until a projection extending axially outwardly from the base end engages a bottom surface of the threaded hole. After the projection engages the bottom surface, a first torque is applied to the stud to further advance the stud into the threaded hole, the first torque being sufficient to force an upper flank of the external thread into engagement with a lower flank of the internal thread. The method may additionally include applying a thread locking fluid between the external and internal threads. A stud capable of performing the method is also disclosed.

### TECHNICAL FIELD

The present disclosure generally relates to fasteners, and more particularly to apparatus and methods for seating in place a threaded stud.

### BACKGROUND

Fasteners are used in many different applications to secure together two or more components or structures. One type of fastener is a stud having opposite ends that are threaded. A first end of the stud may be seated into a first threaded hole provided in a first component, while the second, opposite end of the stud extends outside of the first threaded hole. A second component formed with a second threaded hole may be threaded onto the second end of the stud, thereby to secure or couple the second component to the first component. Alternatively, the second component may be a nut used to secure another component to the stud.

In some applications, it is advantageous to securely seat the first end of the stud in the first threaded hole so that it does not rotate or back out of the first threaded hole during subsequent assembly of the second component. To securely seat the stud, it is known to size the stud relative to the threaded hole so that an interference thread fit is made. The type of fit between threads may be specified with reference to an industry standard, such as metric threads or classifications set by the American National Standards Institute (ANSI). For example, an interference thread fit may be identified by referring to an ANSI Class 5 thread, which specifies that the pitch diameter of the external thread on the stud is greater than the pitch diameter of the internal thread formed in the hole. Thus, a Class 5 thread between the stud and first threaded hole is an interference thread fit that will ensure that the stud is securely seated in the hole. While an interference thread fit satisfies the need to hold the stud in place, it creates manufacturing issues that are difficult and costly. For example, considerable torque is required to drive a Class 5 stud into the threaded hole, and lubrication is necessary to prevent galling and/or seizing of the threads. Thus, seating a stud using Class 5 threads is overly difficult and expensive.

Conversely, the use of a clearance thread fit between the stud and threaded hole may not securely seat the stud. A clearance thread fit may be identified by referring to an ANSI Class 2 thread, which specifies that the pitch diameter of the external thread on the stud is less than the pitch diameter of the internal thread formed in the hole. The use of Class 2 threads creates a looser fit that may allow even a fully inserted stud to move relative to the threaded hole. Consequently, a stud with Class 2 threads may loosen and/or back out of the threaded hole during subsequent assembly or disassembly of the second component, which may lead to improper tensioning of the stud and require additional inspection and reseating of the stud. While a thread locking fluid may be used to bond the stud in the seated position, such thread locking fluids are typically brittle once cured and therefore movement of the stud relative to the threaded hole (as would be permitted by Class 2 threads) may damage the cured fluid and weaken the bond between the stud and the threaded hole.

Accordingly, it would be advantageous to provide a stud seating assembly and method that securely seats the stud without the manufacturing difficulties associated with an interference thread fit.

### SUMMARY OF THE DISCLOSURE

In accordance with one aspect of the present disclosure, a method of seating a stud in a threaded hole includes inserting a base end of the stud into the threaded hole, threadably mating an external thread of the stud with an internal thread of the threaded hole, the external thread being sized to have a clearance thread fit relative to the internal thread, and advancing the stud into the threaded hole until a projection extending axially outwardly from the base end engages a bottom surface of the threaded hole. After the projection engages the bottom surface, the method may further include applying a first torque to the stud to further advance the stud into the threaded hole, the first torque being sufficient to force an upper flank of the external thread into engagement with a lower flank of the internal thread.

In accordance with another aspect of the present disclosure, a stud is provided for use with a threaded hole having a side wall formed with an internal thread and a bottom surface. The stud includes a stud body extending along a stud axis from a base end to a head end, an external thread formed at the base end of the stud and configured to threadably mate with the internal thread of the threaded hole, the external thread being sized to have a clearance thread fit relative to the internal thread, and a projection extending axially outwardly from the base end and sized to engage the bottom surface when the external thread of the stud is mated with the internal thread of the threaded hole.

In accordance with another aspect of the present disclosure, a stud seating assembly includes a threaded hole having a side wall formed with an internal thread and a bottom surface, and a stud. The stud includes a stud body extending along a stud axis from a base end to a head end, an external thread formed at the base end of the stud and configured to threadably mate with the internal thread of the threaded hole, the external thread being sized to have a clearance thread fit relative to the internal thread, and a projection extending axially outwardly from the base end and sized to engage the bottom surface when the external thread of the stud is mated with the internal thread of the threaded hole.

In accordance with another aspect of the present disclosure, which may be combined with one or more of the other aspects, a thread locking fluid is applied in a space between the internal thread of the threaded hole and the external thread of the stud.

In accordance with another aspect of the present disclosure, which may be combined with one or more of the other aspects, the thread locking fluid has a setting period during which the thread locking fluid transitions from a fluid state to a semi-solid state, and in which the first torque is applied during the setting period.

In accordance with another aspect of the present disclosure, which may be combined with one or more of the other aspects, a second torque is applied to the stud after a waiting period to further seat the stud.

In accordance with another aspect of the present disclosure, which may be combined with one or more of the other aspects, the projection defines a planar projection end surface.

In accordance with another aspect of the present disclosure, which may be combined with one or more of the other aspects, the projection defines a conical projection end surface.

In accordance with another aspect of the present disclosure, which may be combined with one or more of the other aspects, a second torque is applied to the stud to further seat the stud.

In accordance with another aspect of the present disclosure, which may be combined with one or more of the other aspects, the external thread of the stud comprises an ANSI Class 2 thread fit relative to the internal thread of the threaded hole

### BRIEF DESCRIPTION OF THE DRAWINGS

FIG. 1 is a side elevation view of a first embodiment of a stud having a projection formed in accordance with the present disclosure;

FIG. 2 is an enlarged side elevation view, in cross-section, of the stud of FIG. 1 inserted into a threaded hole;

FIG. 3 is an enlarged side elevation view, in cross-section, illustrating an interference thread fit between a stud and a threaded hole;

FIG. 4 is an enlarged side elevation view, in cross-section, illustrating a clearance thread fit between the stud of FIG. 1 inserted into the threaded hole, with a lower flank of an external thread of the stud resting on top of an upper flank of an internal thread of the threaded hole; and

FIG. 5 is an enlarged side elevation view, in cross-section, illustrating the stud of FIG. 4 in a seated position with an upper flank of the external thread of the stud forced against a lower flank of the internal thread of the threaded hole.

FIG. 6 is a side elevation view of a second embodiment of a stud having a projection formed in accordance with the present disclosure;

FIG. 7 is an enlarged side elevation view, in cross-section, of the stud of FIG. 6 inserted into a threaded hole;

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Embodiments of a stud seating assembly and method are disclosed that seat a base end of a stud in a threaded hole prior to attaching another component to a head end of the stud. The threaded hole may be formed in a first component, such as a cylinder head for a diesel engine, and the stud may be used to secure a second or auxiliary component, such as a fuel injector body or a rocker arm, to the first component. The stud seating assembly may include a stud having an external thread sized to provide a clearance thread fit with the threaded hole, thereby to facilitate insertion of the stud into the threaded hole. A projection extending axially outwardly from a base end of the stud may be sized to engage a bottom surface of the threaded hole. Once the projection engages the bottom surface, a first torque may be applied to compress the stud, causing it to move to a seated position with an upper flank of the stud external thread engaging a lower flank of the threaded hole internal thread. The seated position is the same position in which the stud is placed when the second component is attached to the head end of the stud, and therefore the stud does not shift within the threaded hole during assembly of the second component onto the head end of the stud. Because the stud does not move from the seated position, a thread locking fluid may be used to further secure the stud in the threaded hole without risking damage to the cured thread locking fluid during subsequent assembly.

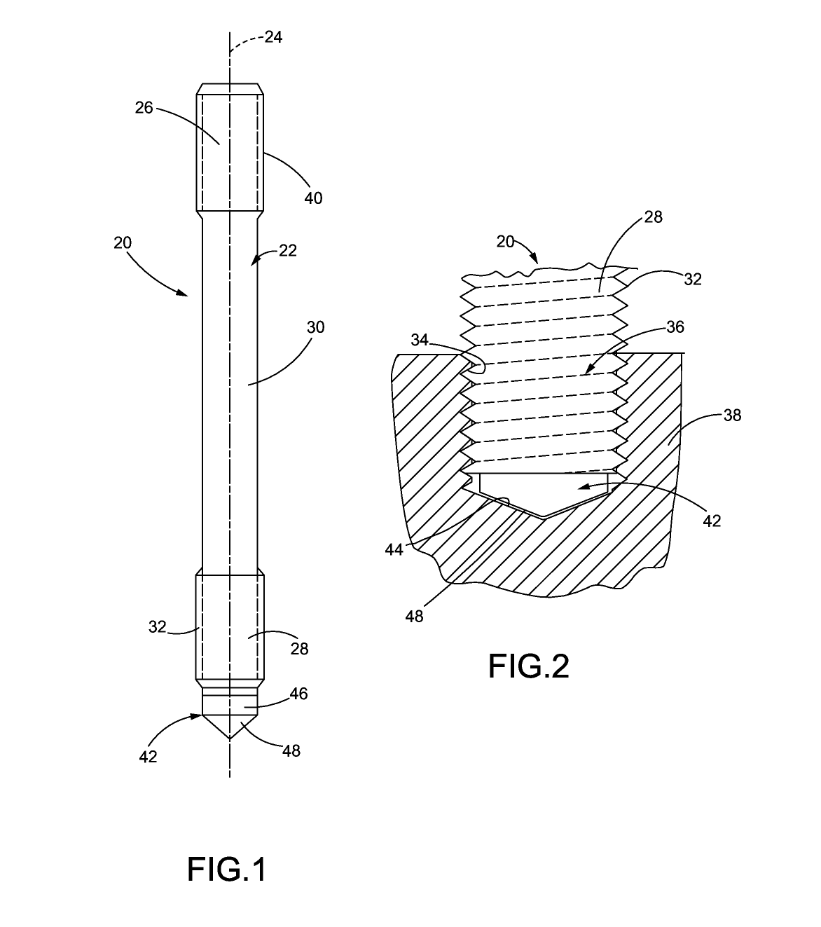

FIG. 1 illustrates a first embodiment of a stud 20 constructed according to certain aspects of the present disclosure. The stud 20 includes a stud body 22 extending along a stud axis 24 and having a head end 26 and a base end 28 joined by a neck 30. The base end 28 is formed with a first external thread 32 configured to engage an internal thread 34 of a threaded hole 36 formed in a first component 38 (FIG. 2). The head end 26 is formed with a second external thread 40 configured to engage a threaded hole formed in a second component (not shown). In some embodiments, the second component is a nut used to secure yet another component onto the stud 20.

The stud 20 further includes a projection 42, as best shown in FIGS. 1 and 2. The projection 42 extends outwardly from the base end 28 along the stud axis 24, and is sized to engage a threadless bottom surface 44 of the threaded hole 36 when the external thread 32 engages the internal thread 34, as best shown in FIG. 2. In the embodiment illustrated in FIG. 1, the projection 42 includes a cylindrical extension 46 and a conical tip 48 defining a projection end surface. In this embodiment, the bottom surface 44 is also conical, so that the projection end surface has a shape that is complementary to the shape of the bottom surface 44. It will be appreciated, however, that the shapes of the projection end surface and the bottom surface 44 need not be complementary.

The external thread 32 may be sized relative to the internal thread 34 to provide a clearance thread fit between the stud 20 and the threaded hole 36. As used herein, the term “thread fit” is used to describe the size of the pitch diameter of the external thread 32 on the stud 20 relative to the size of the pitch diameter of the internal thread 34 on the threaded hole 36. A “clearance thread fit” is used to describe a stud external thread with a pitch diameter that is less than the pitch diameter of a threaded hole internal thread. This is in contrast to an “interference thread fit,” where the pitch diameter of the stud external thread is greater than the pitch diameter of the threaded hole internal thread.

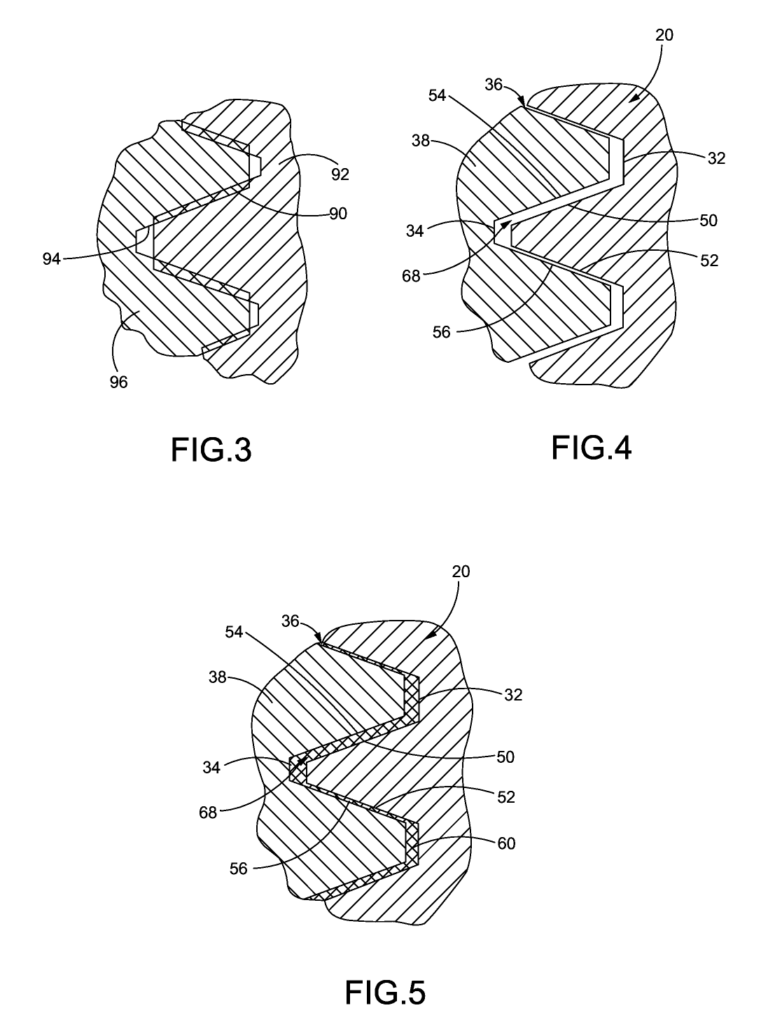

An example of an interference thread fit is illustrated in FIG. 3, where an external thread 90 of a stud 92 has a pitch diameter that is greater than the pitch diameter of an internal thread 94 of a threaded hole 96. Because of the interference thread fit, insertion of the stud 92 into the threaded hole 96 may require a lubricant and is otherwise relatively difficult and complex.

According to the present disclosure, the external thread 32 of the stud 20 is sized to have a clearance fit relative to the internal thread 34 of the threaded hole 36. A clearance thread fit is best shown in FIGS. 4 and 5, in which the pitch diameter of the external thread 32 is less than the pitch diameter of the internal thread 34. In some embodiments, the external thread 32 may be sized to provide an ANSI Class 2 thread fit with the internal thread 34. By using a clearance thread fit, the stud 20 is more easily threaded into the threaded hole 36 with less force and without the need to use lubricant.

The clearance fit between the external thread 32 and the internal thread 34 may allow the stud 20 a limited amount of axial movement within the threaded hole 36. As best shown in FIGS. 4 and 5, the external thread 32 has an upper flank 50 and a lower flank 52. Similarly, the internal thread 34 has an upper flank 54 and a lower flank 56. When the threaded hole 36 is oriented as shown in FIGS. 4 and 5, with an opening of the threaded hole 36 facing upwardly, the stud 20 is inserted into the threaded hole 36 in a vertically downward direction. Consequently, the force of gravity will tend to pull the stud 20 in a downwardly direction to the extent permitted by the clearance thread fit, creating an upper gap 68 between the upper flank 50 of the stud external thread 32 and the lower flank 56 of the hole internal thread 34 as shown in FIG. 4. When the second component is subsequently attached to the head end 26 of the stud, that procedure will create a tension force on the stud 20 which, if the upper gap 68 is present, will cause the stud 20 to shift axially upwardly within the threaded hole until the upper flank 50 engages the lower flank 56.

The projection 42 may be used to compress the stud 20, thereby to hold the stud 20 in a fixed position within the threaded hole 36. More specifically, the stud 20 may be threaded into the threaded hole 36 until the projection end surface defined by the tip 48 engages the bottom surface 44. A first torque applied to the stud 20, thereby to further thread it into the threaded hole 36, will create a compression force on the stud 20, thereby driving the stud 20 axially upwardly within the threaded hole 36 until the upper flank 50 engages the lower flank 56 to create a lower gap 66, as illustrated in FIG. 5. The compression force not only drives the stud 20 to a seated position within the threaded hole 36, but also may resist unthreading of the stud 20 during subsequent operations.

By holding the stud 20 in the seated position to prevent axial shifting of the stud 20, the projection further permits the use of a thread locking fluid 60 to more securely hold the stud 20 in place. As used herein, the term “thread locking fluid” refers to an adhesive that may be applied between the interface of a fastener and a threaded hole to prevent loosening of the fastener. An exemplary thread locking fluid that may be used in the current application is marketed by Henkel Corporation under the LOCTITE trademark, however other types of thread locking fluids may be used. The thread locking fluid 60 may be provided in the form of a liquid that cures anaerobically into a solid polymer. As it cures, the thread locking fluid polymerizes from a liquid state into a solid state. The time it takes for the thread locking fluid to change from the liquid state to a semi-solid state is referred to herein as a “setting period,” which may be on the order of 30 minutes or more. Because the thread locking fluid 60 changes into a solid, shifting of the stud 20 may cause the solid thread locking fluid 60 to crack or damage, thereby reducing its effectiveness at securing the stud 20 in place. By using the projection 42 to hold the stud 20 in the seated position as shown in FIG. 5, however, the stud 20 will not shift within the threaded hole 36 during the setting period, thereby preventing damage to the thread locking fluid 60 once it has cured. Additionally, the stud 20 will not shift when a second component is subsequently assembled onto the head end 26 of the stud 20, which may apply a tension force on the stud 20.

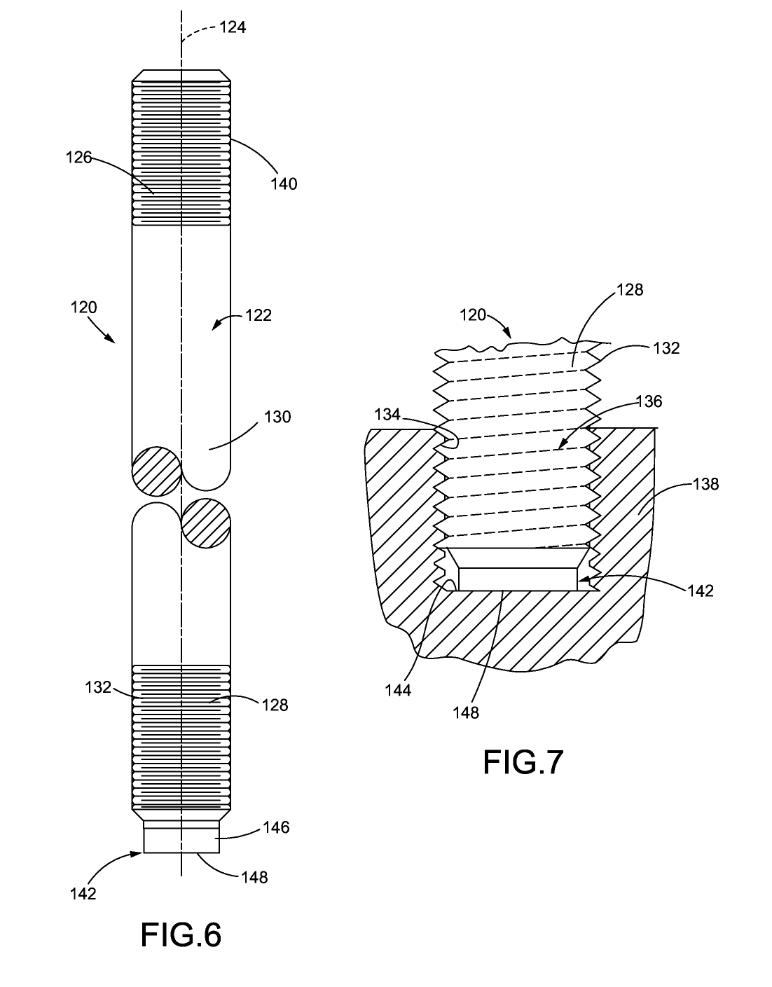

FIG. 6 illustrates a second embodiment of a stud 120 constructed according to the present disclosure. But for the shape of the projection end surface, the stud 120 is similar to the stud 20 described above. Accordingly, the stud 120 has a stud body 122 extending along a stud axis 124, with a head end 126 and a base end 128 joined by a neck 130. The base end 128 has a first external thread 132 for threadably engaging an internal thread 134 of a threaded hole 136 formed in a first component 138 (FIG. 7). The head end 126 is formed with a second external thread 140 configured to threadably engage a second component (not shown).

As best shown in FIGS. 6 and 7, the stud 120 includes a projection 142 extending outwardly from the base end 128 along the stud axis 124. The projection 142 is sized to engage a threadless bottom surface 144 of the threaded hole 136 when the external thread 132 engaging the internal thread, as best shown in FIG. 7. In this embodiment illustrated in FIG. 6, the projection 142 includes a cylindrical tip 148 defining a planar projection end surface. In this embodiment, the bottom surface 144 is also planar. While the projection end surface and bottom surface 144 of this embodiment also have complementary shapes, it will be appreciated that the shapes of the projection end surface and the bottom surface 144 need not be complementary.

### INDUSTRIAL APPLICABILITY

Embodiments of studs are described above having threads sized to provide clearance thread fits with threaded holes, and projections sized to engage bottom surfaces of the threaded holes. These projections allow a user to positively position the stud in a seated position, thereby preventing shifting of the stud during subsequent assembly operations. Holding the stud in a seated position also allows the use of a thread locking fluid, which may help secure the stud in position.

More specifically, a method of a method of seating the stud in a threaded hole is provided. With reference to FIGS. 1-2 and 4-5, the method includes inserting the base end 28 of the stud 20 into the threaded hole 36. The external thread 32 of the stud 20 is threadably mated with the internal thread 34 of the threaded hole 36. As noted above, the external thread 32 is sized to have a clearance thread fit relative to the internal thread 34, thereby to permit easily insertion of the stud 20 into the threaded hole 36. During insertion of the stud 20, the lower flank 52 of the external thread 32 may engage the upper flank 54 of the internal thread 34, as shown in FIG. 4.

Next, the stud 20 is advanced into the threaded hole 36 until the projection 42, which extends axially outwardly from the base end 28, engages a bottom surface 44 of the threaded hole 36. After the projection 42 engages the bottom surface 44, a first torque is applied to the stud 20 to further advance the stud into the threaded hole 36. The first torque is sufficient to force the upper flank 50 of the external thread 32 into engagement with a lower flank 56 of the internal thread 34, which is identified herein as the seated position and is illustrated at FIG. 5.

While the above-described method may adequately seat the stud 20 in the threaded hole 36, some alternative embodiments may include applying a thread locking fluid 60 in a lower gap 66 between the internal thread 34 of the threaded hole 36 and the external thread 32 of the stud 20. For example, the thread locking fluid 60 may be applied to either the external thread 32 or the internal thread 34 prior to insertion of the stud 20 into the threaded hole 36. The thread locking fluid may initially have a liquid state, so that subsequent insertion of the stud 20 into the threaded hole 36 allows the thread locking fluid to move into the lower gap 66. The first torque noted above may be applied to the stud 20 during a setting period of the thread locking fluid (i.e., while the thread locking fluid is still in a liquid state) to ensure that the thread locking fluid will flow into the lower gap 66. Still further, the method may include applying a second torque to the stud 20 after a waiting period to further seat the stud in the seated position.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of seating a stud in a threaded hole, the method comprising;
inserting a base end of the stud into the threaded hole;
threadably mating an external thread of the stud with an internal thread of the threaded hole, the external thread being sized to have a clearance thread fit relative to the internal thread;
advancing the stud into the threaded hole until a projection extending axially outwardly from the base end engages a bottom surface of the threaded hole; and
after the projection engages the bottom surface, applying a first torque to the stud to further advance the stud into the threaded hole, the first torque being sufficient to force an upper flank of the external thread into engagement with a lower flank of the internal thread.

2. The method of claim 1, further comprising applying a thread locking fluid in a space between the internal thread of the threaded hole and the external thread of the stud.

3. The method of claim 2, in which the thread locking fluid has a setting period during which the thread locking fluid transitions from a fluid state to a semi-solid state, and in which the first torque is applied during the setting period.

4. The method of claim 3, further comprising applying a second torque to the stud after a waiting period to further seat the stud.

5. The method of claim 1, in which the projection defines a planar projection end surface.

6. The method of claim 1, in which the projection defines a conical projection end surface.

7. The method of claim 1, further comprising applying a second torque to the stud to further seat the stud.

8. The method of claim 1, in which the external thread of the stud comprises an ANSI Class 2 thread fit relative to the internal thread of the threaded hole.

9. A stud for use with a threaded hole having a side wall formed with an internal thread and a bottom surface, the stud comprising:
a stud body extending along a stud axis from a base end to a head end;
an external thread formed at the base end of the stud and configured to threadably mate with the internal thread of the threaded hole, the external thread being sized to have a clearance thread fit relative to the internal thread; and
a projection extending axially outwardly from the base end and sized to engage the bottom surface when the external thread of the stud is mated with the internal thread of the threaded hole.

10. The stud of claim 9, further comprising a thread locking fluid disposed between the stud and the threaded hole.

11. The stud of claim 9, in which the projection defines a planar projection end surface.

12. The stud of claim 9, in which the projection defines a conical projection end surface.

13. The stud of claim 9, in which the external thread of the stud comprises an ANSI Class 2 thread fit relative to the internal thread of the threaded hole.

14. A stud seating assembly, comprising:
a threaded hole having a side wall formed with an internal thread and a bottom surface; and
a stud including:
a stud body extending along a stud axis from a base end to a head end;
an external thread formed at the base end of the stud and configured to threadably mate with the internal thread of the threaded hole, the external thread being sized to have a clearance thread fit relative to the internal thread; and
a projection extending axially outwardly from the base end and sized to engage the bottom surface when the external thread of the stud is mated with the internal thread of the threaded hole.

15. The stud seating assembly of claim 14, further comprising a thread locking fluid disposed between the stud and the threaded hole.

16. The stud seating assembly of claim 14, in which the projection defines a planar projection end surface.

17. The stud seating assembly of claim 14, in which the projection defines a conical projection end surface.

18. The stud seating assembly of claim 14, in which the external thread of the stud comprises an ANSI Class 2 thread fit relative to the internal thread of the threaded hole.
